(19) United States
(12) Patent Application Publication
(10) Pub. No.: US 2021/0085540 A1
(43) Pub. Date: Mar. 25, 2021

(54) PASSENGER VEHICLE

(71) Applicant: Collins Bus Corporation, South Hutchinson, KS (US)

(72) Inventors: Bryce Pfister, Hutchinson, KS (US); Cody Stefek, Hutchinson, KS (US); John Welch, Hutchinson, KS (US); Trent Fillenworth, Fort Worth, TX (US)

(21) Appl. No.: 16/578,715

(22) Filed: Sep. 23, 2019

(51) Int. Cl. A61G 3/06; B60P 1/43

(52) U.S. Cl. CPC A61G 3/061; B60P 1/431

(57) ABSTRACT

A passenger vehicle that is operable along a ground surface is provided. The passenger vehicle includes a vehicle frame that has a beam with an aperture extending through the beam, a floor at least partially supported by the beam, and a ramp assembly positioned below the floor. The ramp assembly extends through the aperture. The ramp assembly includes a ramp platform that is movable between a stowed position in which the ramp platform extends through the aperture and a deployed position in which the ramp platform extends between the vehicle frame and the ground surface.

### BACKGROUND

The present invention relates to a passenger vehicle, and in particular, a low floor bus having a ramp assembly.

### SUMMARY

In one aspect, a passenger vehicle that is operable along a ground surface is provided. The passenger vehicle includes a vehicle frame that has a beam with an aperture extending through the beam, a floor at least partially supported by the beam, and a ramp assembly positioned below the floor. The ramp assembly extends through the aperture. The ramp assembly includes a ramp platform that is movable between a stowed position in which the ramp platform extends through the aperture and a deployed position in which the ramp platform extends between the vehicle frame and the ground surface.

In another aspect, a passenger vehicle that is operable along a ground surface is provided. The passenger vehicle includes a passenger portion having a vehicle frame that has a beam with an aperture extending through the beam, a floor at least partially supported by the beam, and a ramp assembly positioned below the floor. The aperture has a perimeter that is bounded by the beam. The ramp assembly extends through the aperture and is supported by the beam. The ramp assembly includes a ramp platform that is movable between a stowed position in which the ramp platform extends through the aperture and a deployed position in which the ramp platform extends between the vehicle frame and the ground surface.

Other aspects will become apparent by consideration of the detailed description and accompanying drawings.

### BRIEF DESCRIPTION OF THE DRAWINGS

FIG. 1 is a perspective view of a passenger vehicle according to one embodiment.

FIG. 2 is a perspective view of the passenger vehicle of FIG. 1 with a ramp platform in a deployed position.

FIG. 3 is a schematic view of the passenger vehicle of FIG. 1.

FIG. 4 is a perspective view of a vehicle frame for the passenger vehicle of FIG. 1 illustrating a ramp assembly including the ramp platform in a stowed position.

FIG. 5 is another perspective view of a vehicle frame for the passenger vehicle of FIG. 1 illustrating a ramp assembly including the ramp platform in the stowed position.

FIG. 6 is another perspective view of a vehicle frame for the passenger vehicle of FIG. 1 illustrating a ramp assembly including the ramp platform in the stowed position.

FIG. 7 is another perspective view of a vehicle frame for the passenger vehicle of FIG. 1 illustrating a ramp assembly including the ramp platform in the deployed position.

FIG. 8 is a perspective view of the vehicle frame for the passenger vehicle of FIG. 1 with the ramp assembly removed.

FIG. 9 is a plan view of a portion of the vehicle frame for the passenger vehicle of FIG. 1.

FIG. 10 is an exploded view of the ramp assembly.

FIG. 11 is a cross-sectional view of the ramp assembly taken along a longitudinal axis of the ramp assembly.

FIG. 12A is another beam that is suitable for use in the vehicle frame of FIGS. 4-9.

FIG. 12B is a cross-sectional view through the beam of FIG. 12A along the line 12B-12B.

FIG. 13A is another beam that is suitable for use in the vehicle frame of FIGS. 4-9.

FIG. 13B is a cross-sectional view through the beam of FIG. 13A along the line 13B-13B.

FIG. 14A is another beam that is suitable for use in the vehicle frame of FIGS. 4-9.

FIG. 14B is a cross-sectional view through the beam of FIG. 14A along the line 14B-14B.

FIG. 15A is another beam that is suitable for use in the vehicle frame of FIGS. 4-9.

FIG. 15B is a cross-sectional view through the beam of FIG. 15A along the line 15B-15B.

### DETAILED DESCRIPTION

Before any embodiments of the invention are explained in detail, it is to be understood that the invention is not limited in its application to the details of construction and the arrangement of components set forth in the following description or illustrated in the following drawings. The term “approximately” as defined in this application means plus or minus three inches. The invention is capable of other embodiments and of being practiced or of being carried out in various ways.

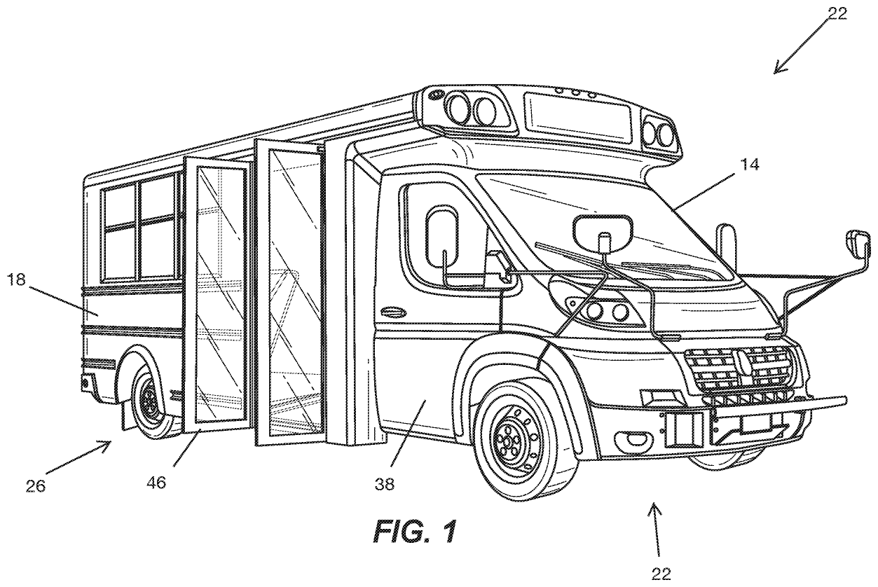

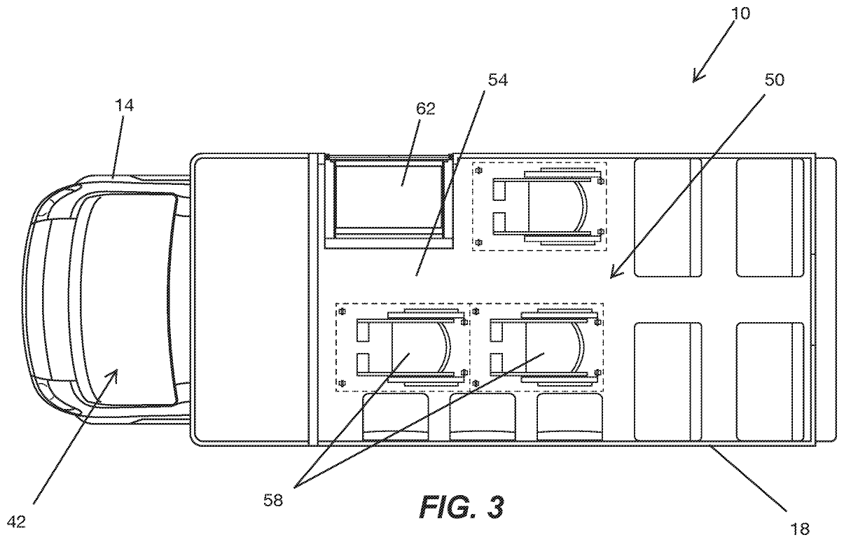

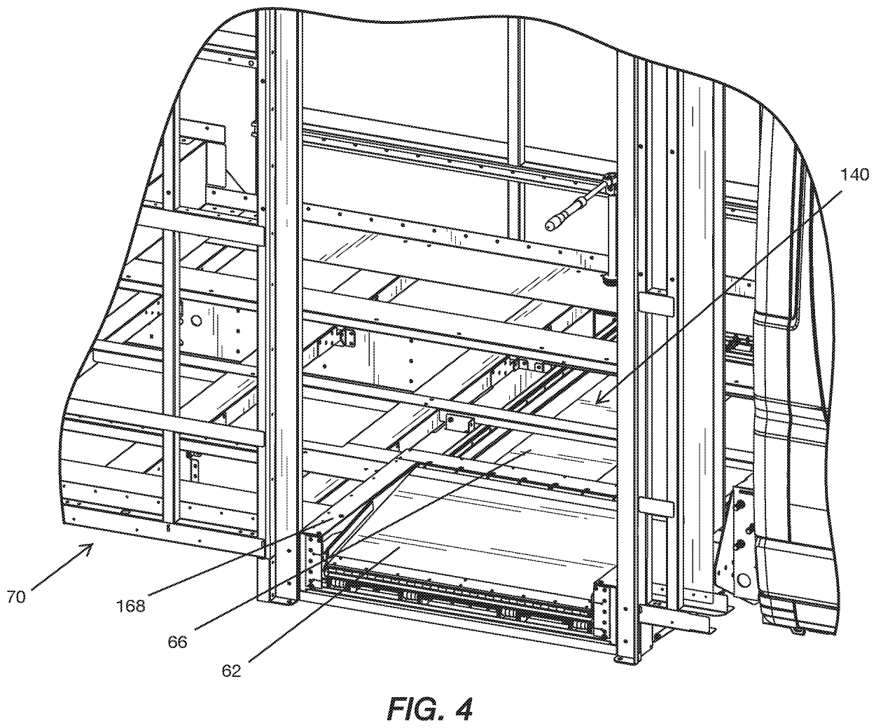

FIGS. 1-3 illustrate a passenger vehicle 10 according to one embodiment. The passenger vehicle 10 is configured to be driven along a ground surface and includes an operator portion 14 and passenger portion 18 coupled to the operator portion 14. A first pair of wheels 22 is rotatably supported by the operator portion 14 and a second pair of wheels 26 (only one of which is shown) is rotatably supported by the passenger portion 18. In other or alternative embodiments, the operator portion 14 and the passenger portion 18 may include additional pairs of wheels. The operator portion includes a motor (not shown) and a steering assembly 34 (not shown) that are operably coupled to one or both pairs of wheels 22, 26. In particular, the motor supplies torque through a transmission (not shown) to one or both of the pairs of wheels 22, 26, and the steering assembly is configured to maneuver one or more of the pairs of wheels 22, 26 to steer the passenger vehicle 10. The operator portion 14 includes at least one door 38 that provides access to an interior 42 (FIG. 3) of the operator portion 14. The passenger portion 18 also includes at least one door 46 that allows access to an interior 50 (FIG. 3) of the passenger portion 18 and a floor 54 (FIG. 3) that supports passenger seats 58 and passengers. Also, an interior ramp 62 (FIGS. 3 and 4) is positioned within the interior 50 of the passenger portion 18 and extends between the floor 54 and the door 46. A ramp platform 66 is supported by the passenger portion 18 and is configured selectively extend from the passenger portion 18.

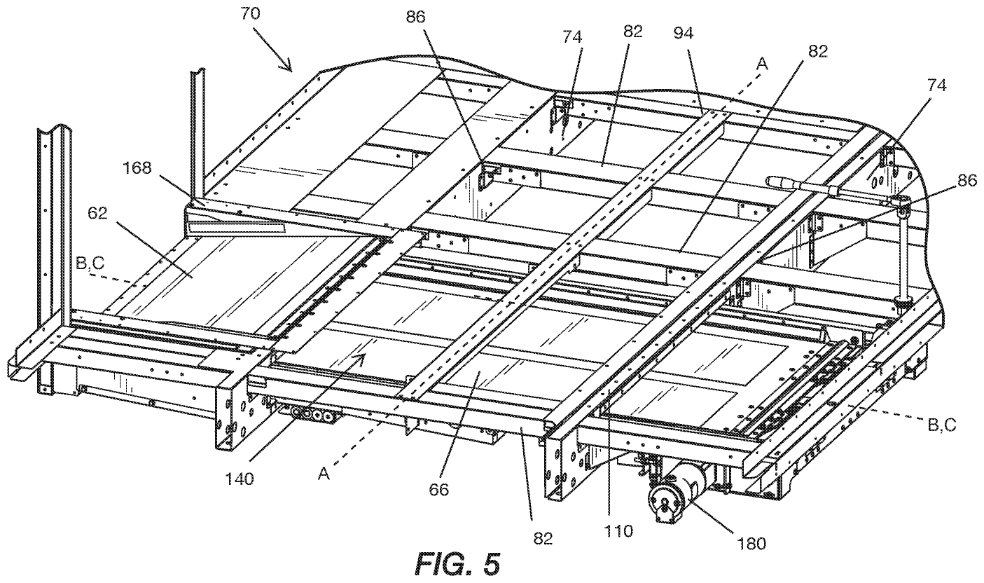

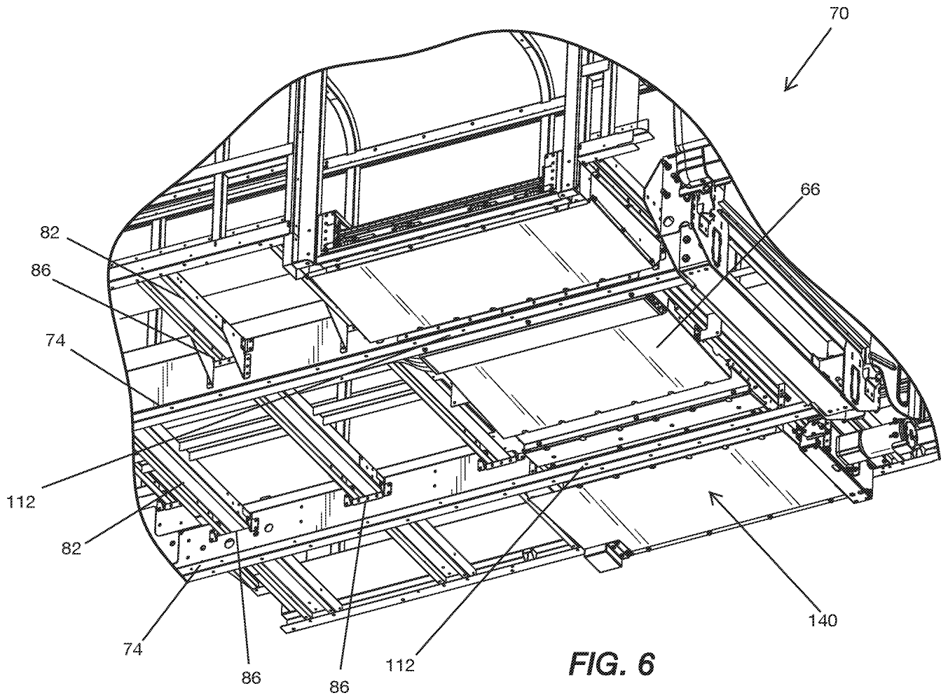

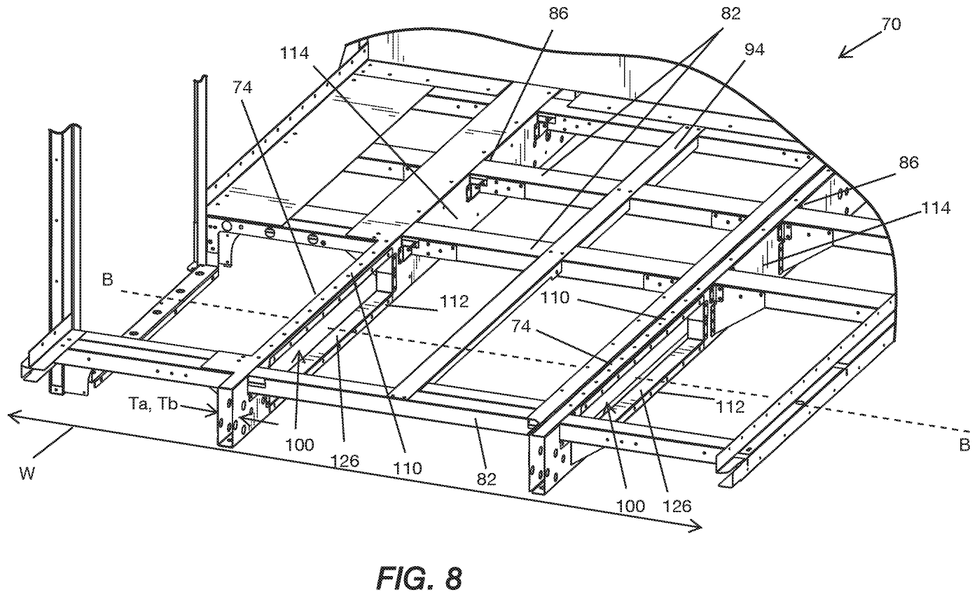

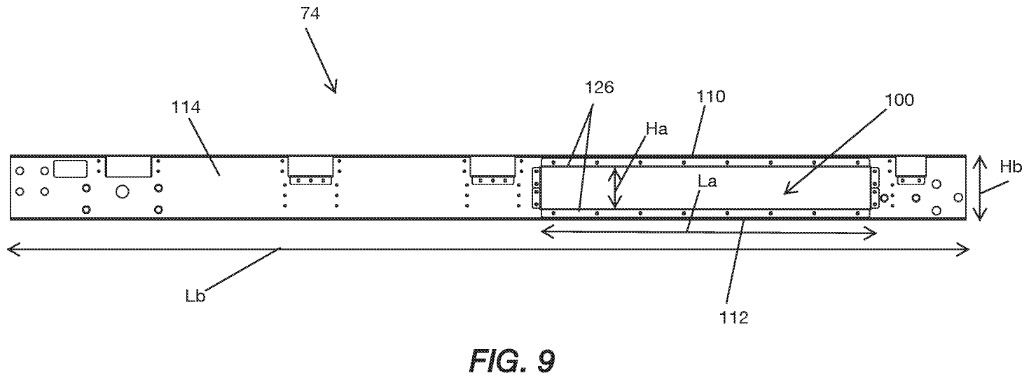

As shown in FIG. 4, the passenger portion 18 includes a vehicle frame 70 that is coupled to the operator portion 14. The vehicle frame 70 has a longitudinal axis A (FIG. 5) that is centered between a first side and a second, opposite side of the vehicle frame 70 and extends from a front to a rear of the passenger portion 18. A width W (FIG. 8) of the vehicle frame 70 is defined between the first and second sides of the vehicle frame 70. As shown in FIGS. 4-7, the vehicle frame 70 includes a beam 74 and a plurality of support members 82 that are supported by the beam 74. The beam 74 is positioned between a first side of the vehicle frame 70 and a second side of the vehicle frame 70, while the plurality of support members 82 extend between the first and second sides of the vehicle frame 70. In the illustrated embodiment, the beam 74 is oriented parallel to the longitudinal axis A and the support beams 82 are oriented transverse to the longitudinal axis A. The beam 74 supports the floor 54 and has a thickness T_{b} (FIG. 8) and height H_{b} (FIG. 9). The beam 74 has a length L_{b} (FIG. 9), which varies according to the type of passenger vehicle 10. In the illustrated embodiment, each of support members 82 are supported within pockets or recesses 86 in the beam 77. The recesses 86 are sized and shaped to receive the support member 82. In the illustrated embodiment, the vehicle frame 70 includes an auxiliary support member 94 that extends parallel to the longitudinal axis A and is supported by one or more of the plurality of support members 82.

With respect to FIGS. 8 and 9, the beam 74 has an aperture 100 extending through the beam 74. An axis B extends through center of the aperture 100. The axis B is transverse to the longitudinal axis A in the illustrated embodiment. The aperture 100 extends between two support members 82. One of the support members 82 is adjacent a first end of the aperture 100 and another of the support members 82 is adjacent a second end of the aperture 100. As shown in FIGS. 8 and 9, the aperture 100 is an elongated aperture and has a rectangular cross-section. With respect to FIG. 9, a length Lₐ of the aperture 100 is greater than a height Hₐ of the aperture 100. Also, a perimeter of the aperture 100 is defined by the material of the beam 74.

Further with respect to FIGS. 8, 9, and 12A-12B, in the illustrated embodiment, beam 74 is-a rectangular, hollow beam. Accordingly, the beam 74 has a first side (e.g., a first horizontal section) 110, a second side (e.g., a second horizontal section) 112, and a web 114 (e.g., vertical section) extending between the first side 110 and the second side 112. The web 114 includes a third side (e.g., a first vertical section) of the beam 74 and a fourth side (e.g., a second vertical section) of the beam 74, which is spaced apart from the third side. The third and fourth sides of the beam are integrally formed with and extend between the first and second sides 110, 112. In the illustrated embodiment, the thickness of the first and second sides 110, 112 is equal to the thickness of the web 114, but in other or additional embodiments, the thickness of the sides 110, 112 may be greater than the thickness of the web 114. The aperture 100 extends through the web 114. As shown in FIG. 9, the aperture 100 is fully bounded (e.g., bounded on all sides) by the web 114. The first side 110 at partially supports the floor 54. Reinforcement members 126 are coupled (e.g., by fasteners, adhesive, or any other suitable coupling mechanism) to each side of the aperture 100 (e.g., to a perimeter of the aperture 100) and to opposite surfaces of the beam 74. The reinforcement members 126 create a continuous surface of the aperture 100 and to help the first and second sides 110, 112 of the beam 74 resist local buckling or bending. In the illustrated embodiment, the beam 74 is a unitary beam formed from a single piece with the aperture 100. In other embodiments, the beam 74 can be formed from multiple structural members that are coupled to form and/or define the aperture 100.

Further with respect to FIG. 9, the length Lₐ of the aperture 100 is less than the length L_{b} of the beam 74, and the height Hₐ of the aperture 100 is less than the H_{b} of the beam 74. A thickness Tₐ of the aperture 100 is the same as the thickness T_{b} of the beam 74. The height Hₐ of the aperture 100 is at least 25% of the height H_{b} of the beam 74, and the aperture 100 is vertically centered in the beam 74. Accordingly, a height of each of the first side 110 and the second side 112 is substantially the same. In the illustrated embodiment, for example, the height Hₐ of the aperture 100 is 62.5% of the height H_{b} of the beam 74, and the height of each of the first and second flanges 110, 112 is 18.75%. In other embodiments, the aperture 100 be vertically offset from the center of the beam 74.

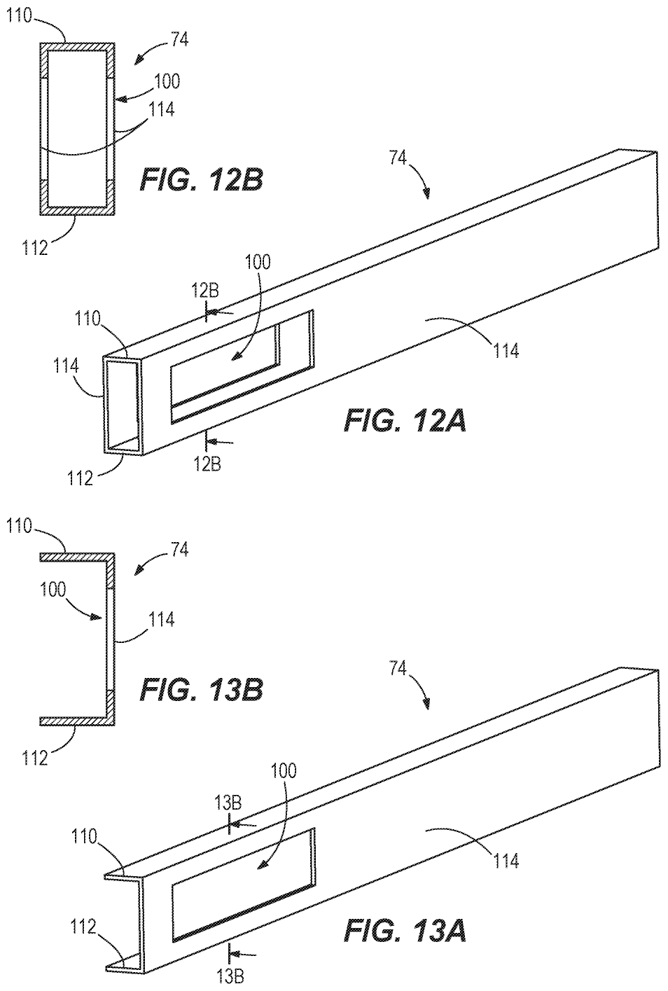

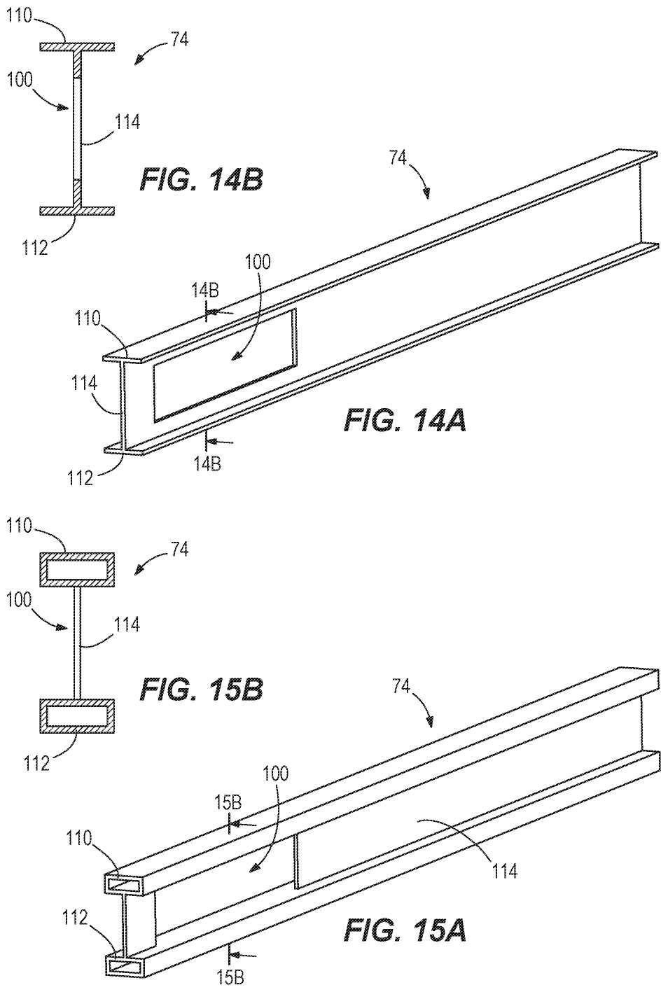

While the illustrated beams are rectangular hollow beams, the beams may have other configurations, such as I-beams, H-beams, C-channel beams, U-channel beams, tubing, among other suitable configurations. For example, FIGS. 13A-15B illustrate the cross-sections of beams 74 having different configurations. FIGS. 13A-14B illustrate a beams 74 with a web 114 having a single vertical section that is integrally formed with the first and second sides 110, 112. As shown, the first and second sides 110, 112 have a thickness that is greater than a thickness of the web 114. FIGS. 13A and 13B is an I-beam so the web 14 is positioned centrally relative to the first and second sides 110, 112. FIGS. 14A and 14B is a C-beam so the web 114 is positioned at one end of the first and second sides 110, 112. In FIGS. 15A and 15B, the beam 74 is a truss and each of the first and second sides 110, 112 are rectangular hollow beams coupled by web 14 that is a single vertical section. As shown in FIGS. 12A-14B, the aperture 100 may span only a portion of a height of the web 114 and therefore have a height that is smaller than the height of the web 114. Alternatively, as shown in FIGS. 15-15B, the aperture 100 may span the entire height of the web and therefore have substantially the same height as the web 114.

Although the above description only references a single beam 74, it should be understood the number of beams 74, and therefore apertures 100, of the vehicle frame 70 is defined by the width W of the vehicle frame 70. In the illustrated embodiment the vehicle frame 70 has two beams 74, and therefore two apertures 100, the above-description applies to both beams 74. Both illustrated beams 74 and apertures 100 have the same features and therefore are demarcated by the same references numerals. In other or additional embodiments, there may be a single beam 74 and a single aperture 100 or more than two beams 74 and more than two apertures 100.

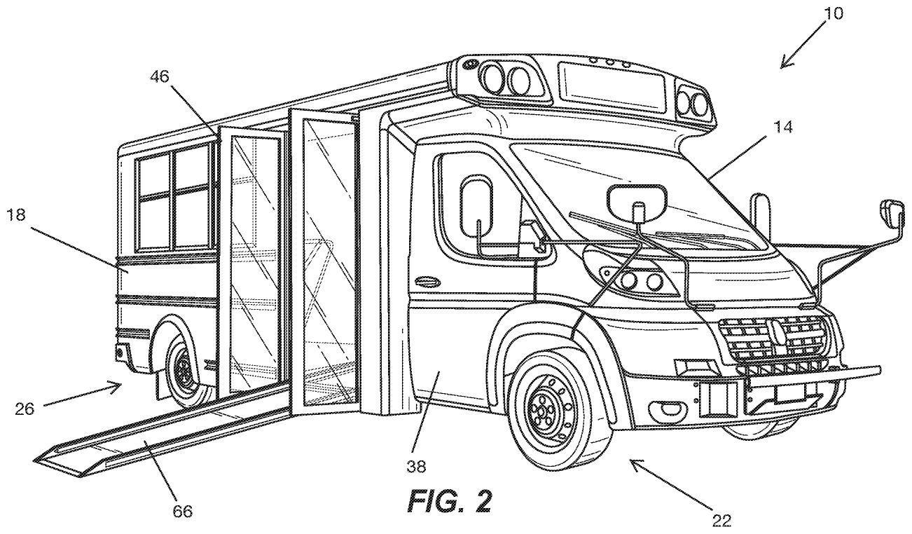

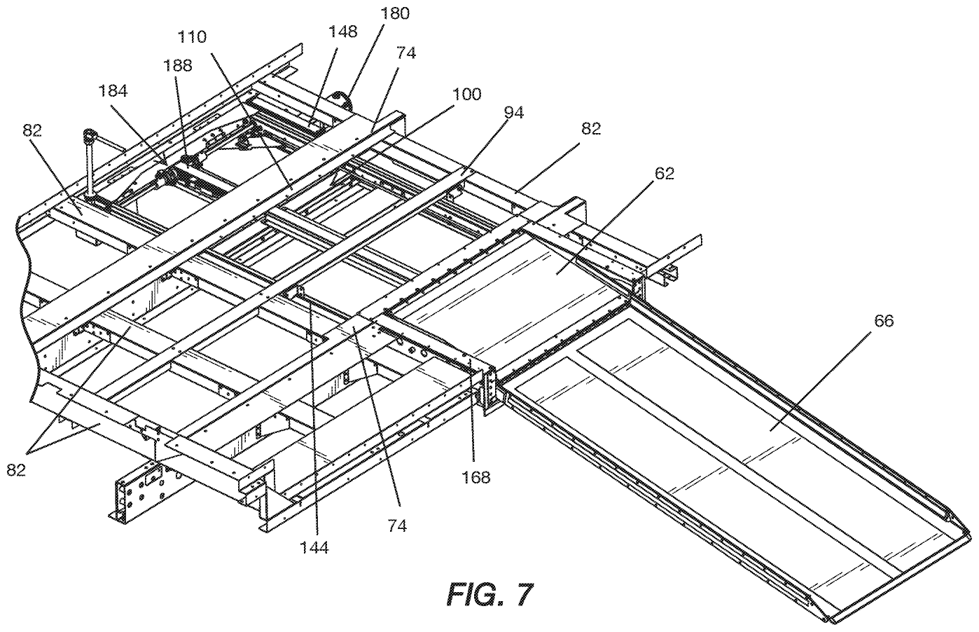

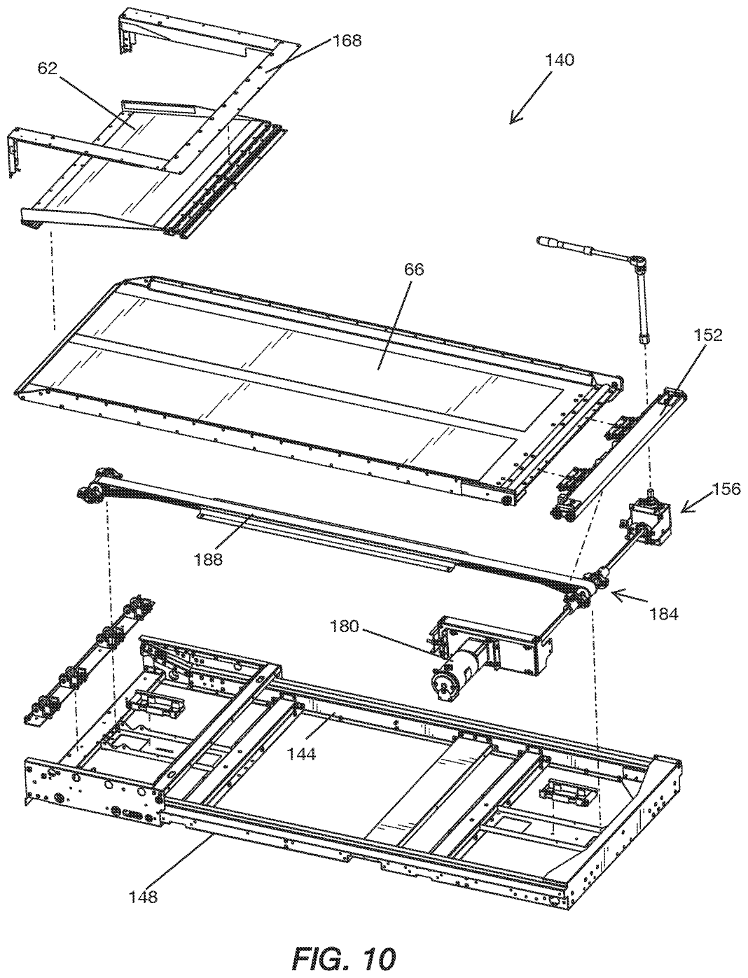

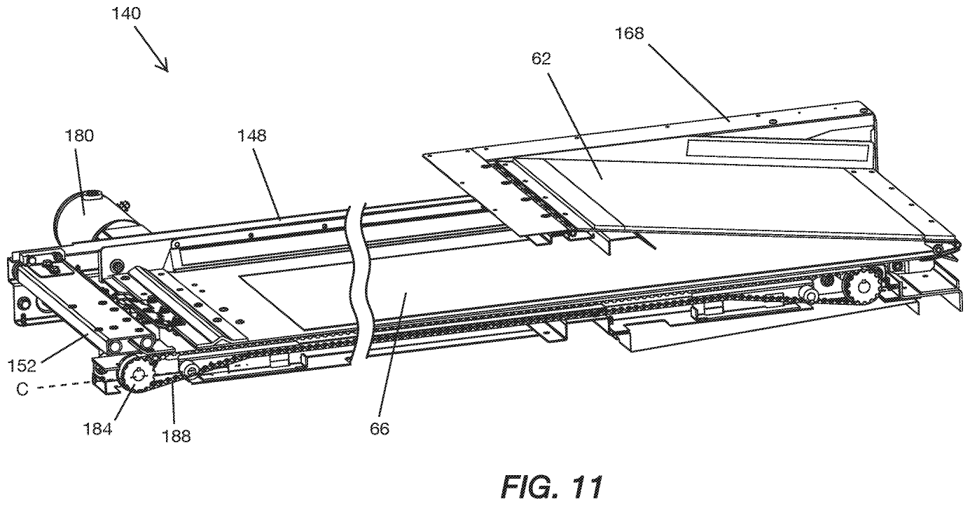

As shown in FIGS. 4-9, a ramp assembly 140 is positioned below the floor 54 and the ramp assembly 140 is supported by the beams 74. The ramp assembly 140 extends through the apertures 100. With respect to FIGS. 10-11, the ramp assembly 140 includes a ramp axis C (FIG. 11), a first ramp support member 144, a second ramp support member 148, the ramp platform 66, a carrier 152, and a drive mechanism 156. The ramp axis C is parallel to the axis B. In the illustrated embodiment, the ramp assembly 140 is positioned adjacent the door 46 such that the ramp platform 66 is movable to extend from the passenger portion 18 through the door 46. As shown in FIG. 7, the first and second ramp support members 144, 148 extend through the apertures 100 parallel with axis B, and are positioned on opposite sides of the apertures 100. The first ramp support member 144 is positioned within the apertures 100 on the first side of the aperture 100 and second ramp support member 148 is positioned within apertures 100 on the second side of the apertures 100. A frame 168 of the interior ramp 62 is supported by the first and second ramp support members 144, 148. The ramp platform 66 is movably supported by and between the first and second ramp support members 144, 148. The carrier 152 is hingedly coupled to a distal end of the ramp platform 66. The drive mechanism 156 is configured to move the ramp platform between a stowed position (FIGS. 1, 4, 5, and 6) and a deployed position (FIGS. 2 and 7).

The drive mechanism 156 includes a drive motor 180 that is operably coupled to a pair of drive sprockets 184, which are operably coupled to a drive belt 188. The drive belt 188 extends along parallel to the ramp axis C and is coupled to the carrier 152. In the stowed position, the ramp platform 66 is nonusable and is positioned within the vehicle frame 70. In particular, the ramp platform 66 extends through the apertures 100 and includes an upper portion of the beam above the ramp and a lower portion of the beam below the ramp. In the deployed position, the ramp platform 66 extends between the vehicle frame 70 and the ground surface and is not positioned in the apertures 100. When the operator actuates the drive motor 180 in a first direction (e.g., by a button or other suitable actuator positioned within the operator portion), the drive motor 180 rotates the pair of drive sprockets 184 in a first direction, which rotates the drive belt 188 in a first direction. Accordingly, the drive belt 188 moves the ramp platform 66, via the carrier 152, from the stowed position to the deployed position. When the operator actuates the drive motor 180 in a second direction (e.g., by the same button, another button, or other suitable actuator positioned within the operator portion), the drive motor 180 rotates the pair of drive sprockets 184 in a second direction, which rotates the drive belt 188 in a second direction. Accordingly, the drive belt 188 moves the ramp platform 66, via the carrier 152, from the deployed position to the stowed position.

Because the ramp assembly, including the ramp platform 66 is positioned within the apertures 100, the ramp assembly 140 is supported by the beams 74 while maintaining a floor 54 with a low ground clearance. That is, the ramp assembly 140 is supported within the vehicle frame 70 (e.g., within the beams 74) rather than above or below the vehicle frame 70. The American's With Disabilities Act (ADA) has several requirements for passenger vehicle ramp platforms. For example, the slope of the ramp platform of a passenger vehicle from the ground to the floor of the passenger vehicle is limited to 1:6 (e.g., 9.48 degrees). The slope of the ramp platform is therefore directly related to the height of the floor of the passenger vehicle above the ground. Also, the length of the ramp platform is limited by the width of the vehicle, so the length of the passenger vehicle also limits the length of the ramp platform. For example, if the width of the passenger vehicle can support a ramp platform that is 84 inches, then the ground clearance must be 14 inches to achieve the required 1:6 slope. Placing a ramp assembly, including the ramp platform, above or below the frame increases the overall height of the floor, which means that a kneeling suspension must be incorporated into the passenger vehicle because a kneeling suspension allows the vehicle frame to be lowered and raised to achieve the necessary ground clearance height (14 inches in this example). An alternative to adding a kneeling suspension is having a thinner (and weaker) vehicle frame such that adding the ramp assembly above or below the vehicle frame does not exceed the required ground clearance. Still another alternative to a kneeling suspension is a fold-out ramp assembly, which takes the place of the interior ramp 62. In contrast, placing the ramp assembly 140 within the frame (e.g., within the beams 74) enables the lowest possible floor 54 (e.g., the lowest possible ground clearance) while maintaining the height, strength, and stability of the vehicle frame 70. Because the height of the floor 54 is shorter, the passenger vehicle 10 may not require a kneeling suspension system, which lowers and raises the passenger vehicle 10 to the appropriate heights or the use of a fold-out ramp,

Various features and advantages of the invention are set forth in the following claims.

What is claimed is:

1. A passenger vehicle that is operable along a ground surface, the passenger vehicle comprising:
a vehicle frame including a beam that has an aperture extending through the beam;
a floor at least partially supported by the beam; and
a ramp assembly positioned below the floor, the ramp assembly extending through the aperture, the ramp assembly including a ramp platform that is movable between a stowed position in which the ramp platform extends through the aperture and a deployed position in which the ramp platform extends between the vehicle frame and the ground surface.

2. The passenger vehicle of claim 1, wherein the aperture is an elongated aperture.

3. The passenger vehicle of claim 1, wherein the beam includes a first horizontal section, a second horizontal section opposite the first horizontal section, and a vertical section integrally formed with and extending between the first and second horizontal sections, the aperture extending through the vertical section.

4. The passenger vehicle 1, wherein a perimeter of the aperture is defined by the beam.

5. The passenger vehicle of claim 1, wherein the aperture is fully bounded by the beam.

6. The passenger vehicle of claim 1, wherein
the beam defines a length, a thickness, and a height, and
the aperture defining a length, a thickness, and a height,
wherein the length of the aperture is less than the length of the beam and the height of the aperture is less than the height of the beam.

7. The passenger vehicle of claim 6, wherein the height of the aperture is at least 25% of the height of the beam.

8. The passenger vehicle of claim 1, wherein the vehicle frame further includes a reinforcement member coupled to each side of the aperture and to opposite surfaces of the beam.

9. The passenger vehicle of claim 1, wherein the vehicle frame further includes a first support member and a second support member, each of the first and second support members being supported by the beam, the first support member being positioned adjacent a first end of the aperture and the second support member being positioned adjacent a second end of the aperture.

10. The passenger vehicle of claim 1, wherein the ramp assembly further includes
a first ramp support member positioned within the aperture on a first side,
a second ramp support member positioned within the aperture on a second side, the ramp platform being movably positioned between the first ramp support member and the second ramp support member;
a carrier hingedly coupled to a distal end of the ramp platform, and
a drive mechanism operably coupled to the carrier and configured to move the ramp platform between the stowed position and the deployed position.

11. A passenger vehicle that is operable along a ground surface, the passenger vehicle comprising:
a passenger portion having a vehicle frame including a beam, and an aperture extending through the beam, the aperture having a perimeter that is bounded by the beam;
a floor at least partially supported by the beam; and
a ramp assembly positioned below the floor, the ramp assembly extending through the aperture and supported by the beam, the ramp assembly including a ramp platform that is movable between a stowed position in which the ramp platform extends through the aperture and a deployed position in which the ramp platform extends between the vehicle frame and the ground surface.

12. The passenger vehicle of claim 11, wherein the vehicle frame further includes a first support member and a second support member, each of the first and second support members being supported by the beam, the first support member being positioned adjacent a first end of the aperture and the second support member being positioned adjacent a second end of the aperture.

13. The passenger vehicle of claim 11, wherein the vehicle frame further includes a reinforcement member coupled to the perimeter of the aperture.

14. The passenger vehicle of claim 11, wherein the beam includes a first horizontal section, a second horizontal section opposite the first horizontal section, and a vertical section integrally formed with and extending between the first and second horizontal sections, the aperture extending through the vertical section.

15. The passenger vehicle of claim 14, wherein the aperture is fully bounded by the web.

16. The passenger vehicle of claim 11, wherein
the beam defines a length, a thickness, and a height, and
the aperture defining a length, a thickness, and a height,
wherein the length of the aperture is less than the length of the beam and the height of the aperture is less than the height of the beam.

17. The passenger vehicle of claim 16, wherein the height of the aperture is at least 25% of the height of the beam.

18. The passenger vehicle of claim 11, wherein the ramp assembly further includes
a first ramp support member positioned within the aperture on a first side,
a second ramp support member positioned within the aperture on a second side, the ramp platform being movably positioned between the first ramp support member and the second ramp support member;
a carrier hingedly coupled to a distal end of the ramp platform, and
a drive mechanism operably coupled to the carrier and configured to move the ramp platform between the stowed position and the deployed position.
